(19) United States
(12) Patent Application Publication
(10) Pub. No.: US 2025/0268340 A1
(43) Pub. Date: Aug. 28, 2025

(54) DEVICE FOR IN-POSITION SECURING OF STRAP AND ITS LOOSE END

(71) Applicant: Troy Innovations Limited, Great Shefford (GB)

(72) Inventor: William Alexander Piers Troy, Great Shefford (GB)

(21) Appl. No.: 19/061,388

(22) Filed: Feb. 24, 2025

(30) Foreign Application Priority Data
Feb. 27, 2024 (GB) 2402737.7

(51) Int. Cl. A44B 11/12

(52) U.S. Cl. CPC A44B 11/125

(57) ABSTRACT

Disclosed is a device (100, 400, 500, 600) for in-position securing at least one loose end (112A, 112B, 402A, 402B, 410A, 410B) of at least one strap (112, 402, 410). The device comprises an extension element (102, 210,502A, 502B, 502C, 502D, 602, 604) having at least one first end (102A, 210, 504A, 504B, 504C, 504D, 602A, 604A) and at least one second end (102B, 506A, 506B, 506C, 506D, 602B, 604B), the extension element comprises a first section (104, 510, 602C, 604C), having a length (L), extending between the at least one first end and the at least one second end, and a second section (106, 300, 512, 602D, 604D) arranged along the length of the first section such that ends (106A, 106B, 308, 310) of the second section are attached to the first section; and a fastener (108A, 108B, 200, 404A, 404B, 516A, 516B, 516C, 516D, 610A, 612A, 610B, 612B) arranged on at least one corresponding at least one first end or at least one second end of the extension element, the at least one fastener configured to receive the corresponding loose end of the at least one strap therethrough.

### TECHNICAL FIELD

The present disclosure relates to a device for in-position support and securing of straps and loose ends of straps. More specifically, the disclosure relates to a device for in-position support and securing of straps and loose end of straps in sports equipment, especially for use in rowing machine equipment.

### BACKGROUND

Generally, the straps are flexible bands or strips, typically made of various materials such as fabric, plastic, leather or metal. The straps come in different shapes and types, each designed for a specific application in various industries and activities, such as outdoor gear, luggage, sports equipment (for example rowing machine), safety equipment or manufacturing and transportation of objects. For example, in a sporting equipment, such as a rowing machine, it is desirable to secure the position of a user's foot to avoid any potential accident or damage to the user and/or equipment due to instability.

Conventionally, foot straps are provided on sports equipment such as rowing machine. However, the existing foot straps for providing the stability and controlled fit on sports equipment are associated with several limitations. In an example, during a rowing exercise regime on a public row machine, the user is required to tighten the foot straps multiple times during their exercise regime, this is due to the fact that a “one size fits all” adjustable strap is used on most public rowing machines. It may be appreciated that such loose straps in sporting equipment reduces efficacy and causes instability during the exercise regime, such as while securing the position of the users' foot of different sizes. An alternative solution to said problem is to carry personal foot straps during the exercise regimen.

However, it may not be convenient to remember to carry and install such personal foot straps on the sports equipment every time.

Moreover, a walker's rucksack has many straps having corresponding loose ends. In such an example, the straps of the rucksack may be used to secure items (within a volume of the rucksack as well as those arranged on an exterior side the rucksack) and adjust the rucksack to the walker's comfort levels. However, such loose ends may potentially get stuck to different objects on the walkway and hinder the walk. A conventional solution to manage such loose ends of the straps of the walker's rucksack is to tie the loose ends of the straps together, such as around the additional item to be carried. However, the tying together of the loose ends of the straps does not guarantee a safe carrier for the additional item to be carried. Moreover, releasing the tied loose ends of the straps may not always be convenient for the walkers, such as children and/or old age walkers, or walkers with grip inability or limited hand strength.

Therefore, considering the foregoing reasons, there is a need to overcome the aforementioned drawbacks.

### SUMMARY

The aim of the present disclosure is to provide a device that is arranged to bridge the loose ends of the straps and secure them in-position for a duration and adjust the straps to user's comfort levels. Moreover, it provides support to the setup, by introducing a connection between the strap ends, and providing a means to add tension between them. The aim of the present disclosure is achieved by a device for in-position securing of a strap and the loose end(s) of the strap as defined in the appended independent claim to which the reference is made. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers, or steps not explicitly disclosed also to be present. Moreover, the singular encompasses the plural unless the context requires otherwise. In particular, where the indefinite article is used, the specification is to be understood as contemplating plurality as well as singularity, unless the context requires otherwise.

### BRIEF DESCRIPTION OF THE DRAWINGS

FIGS. 1A, 1B and 1C are illustrations of a device in a relaxed state, a partially-stressed state and a stressed state, respectively, in accordance with an embodiment of the present disclosure;

FIG. 2 is an illustration of a fastener, in accordance with an embodiment of the present disclosure;

FIG. 3 is an illustration of a preassembled second section, in accordance with an embodiment of the present disclosure;

FIGS. 4A and 4B are illustrations of exemplary implementations of a device, in accordance with an embodiment of the present disclosure; and

FIGS. 5 and 6 are schematic illustrations of a device in a relaxed state thereof, in accordance with an alternative embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a device for in-position securing at least one loose end of at least one strap, the device comprising:
an extension element having at least one first end and at least one second end, the extension element comprising
   a first section, having a length (L), extending between the at least one first end and the at least one second end; and
   a second section arranged along the length of the first section such that ends of the second section are attached to the first section; and
a fastener arranged on at least one corresponding at least one first end and the at least one second end of the extension element, the fastener configured to receive the corresponding loose end of the at least one strap therethrough.

The first aspect of the present disclosure provides a device that offers several advantages for in-position securing of a strap and loose end(s) of the strap. In this regard, the extension element with the fastener(s) is used to ensure efficient and controllable in-position securing of the loose end(s) of the strap and the strap as a whole. The integration of first section on the extension element allows to limit the maximum distance between the ends of extension element, which ensures controlled and secure fit. On the other hand, the second section contributes to maintaining a consistent tension between the fasteners, creating an antagonistic pairing effect that helps in keeping the straps fully tightened. Beneficially, the device enhances the usability and safety of various products (such as equipment or carriers) that rely on such straps with limited or compromised adjustable properties.

Throughout the present disclosure, the term “device” as used herein refers to an apparatus or an equipment, used for the purpose of fastening (or securing) loose (namely, free or unsecured) end(s) of the strap and supporting the strap as a whole. The term “strap” as used herein refers to an elongated strip or band with limited adjustable properties. Typically, the loose end represents the remaining or unutilized length of the strap that extends beyond the point where the strap is tightened. Typically, a given strap has two ends. It may be appreciated that the strap may have only one loose end while the other end of the strap is fixed to an object. Optionally, the strap is made up of different materials including, but not limited to, a natural fabric material, nylon, polyester, elastomers, and plastic.

The device may serve as an extension element that extends from the loose end(s) of the strap, when in use, to fasten or hold in-position an object, arranged in between the loose ends of straps, in its desired designated position. In this regard, the primary function of the device is to enhance user comfort while using products (namely machines, bags, seats, etc.) employing a strap arrangement. Optionally, the device may be designed in varying sizes and strengths depending upon the application thereof. For example, the device is configured to secure in position a foot of a user or an additional item being carried in a rowing machine or a walker rucksack and during transportation of goods, respectively. Herein, the device is configured to bridge the loose end(s) of existing straps, so that the object will not move from its desired position, due to the improper tightening of the strap or release of tightening of the straps over a period of time.

The term “extension element” as used herein refers to an elongated part (or element) of the device that provides flexibility and adjustability thereto.

It may be appreciated that based on the application of the device, the extension element may be designed to have a plurality of shapes. In this regard, the extension element has at least one end, i.e., first end, second end, third end, etc. In an example, a simple design comprises a single extension element, having two ends, namely a first end and a second end thereof. In another example, two extension elements may be arranged such that the two extension elements intersect each other to form a cross-like design. In such case, the device has four ends of the extension elements, namely a first end and a second end of first extension element and a third end and a fourth end of second extension element. In yet another example, two extension elements may be arranged such that the two extension elements are arranged (by means of an attachment thereof) back-to-back to form a cross-like design. In such case, the device has four ends of the extension elements, namely a first end and a second end of first extension element and a third end and a fourth end of second extension element. In still another example, three extension elements may be arranged such that the three extension elements form a fork-like design. In such case, the device has four ends of the extension elements, namely a first end corresponding to each of the four extension elements and a second end of first extension element while second ends of a second extension element and a third extension element are attached to each other.

In an embodiment, the device can have two ends. The terms “first end” and “second end” as used herein refer to two opposite extreme points (extremities) of the extension element. Typically, the extension element extends between the loose ends of the strap, when the device is in use, and provides a secure (stable) and controlled fit (adjustable) around the object encircled thereby. Notably, the extension element is designed to adjust itself according to the dimensions of the object, such as means of two different sections between the first and the second end of the extension element. In this regard, the extension element comprises the first section that ensures securing, and the second section that ensures controlled fit around the object.

The term “first section” as used herein refers to an elongate segment, having a length (L), extending between the first end and the second end of the extension element. The term “second section” as used herein refers to a distinct elongate segment that is arranged along the length of the first section. Herein, the term “along the length” relates to a spatial relationship between the second section and the first section, wherein the second section is positioned in alignment with the length of the first section. In other words, the second section extends alongside the first section in a linear or parallel arrangement.

Notably, the length (L′) of the second section is shorter than the length (L) of the first section. Optionally, the length of the second section is 20%-80% shorter than the length of the first section. Optionally, the length of the first section is in the range of 2 to 100 cm. Optionally, the length of the first section may be in the range of 2, 4, 6, 8, 10, 20, 40, 60 or 80 cm up to 4, 6, 8, 10, 20, 40, 60, 80 or 100 cm. Optionally, the length of the second section is in a range of 1.6 to 80 cm. Optionally, the length of the second section may be in a range of 1.6, 2, 4, 6, 8, 10, 20, 40 or 60 up to 2, 4, 6, 8, 10, 20, 40, 60 or 80 cm.

Optionally, the second section is arranged along at least partially middle region of the length of the first section. The term “partially middle region” as used herein refers to a part or an intermediate portion of the length of the first section between the first and second ends of the extension element. Notably, the middle region is a central portion that is equidistant from the ends of the elongated extension element, specifically, the first section. However, the term “at least partially middle region” refers to an intermediate portion that may or may not be equidistant from the ends of the elongated extension element, specifically, the first section. In this regard, the middle region of the first section is not fully covered or utilized, but rather only partially involved. In other words, the second section may be arranged along the at least partially middle region of the length of the first section such that the middle region of the length of the first section is present; however, the second section may be either at the centre of the first section or more inclined towards any of the first end or the second end of the extension element. Alternatively, the second section may be attached anywhere along the length of the first section except at the first end or the second end of the extension element. In this regard, a first end of the second section is attached on the at least partially middle region of the first section towards the corresponding first end of the extension element and a second end of the second section is attached on the at least partially middle region of the first section towards the corresponding second end of the extension element, at a first attachment point and a second attachment point of the extension element, respectively. Moreover, the ends of the second section are attached to the first section at the first attachment point and the second attachment point of the extension element, respectively, by means of any of: an adhesive, a stitch, hooks, snap buttons, Velcro®, or any suitable combination thereof.

Optionally, the first section is implemented as a non-elasticated section, and the second section is implemented as an elasticated section. The term “non-elasticated section” as used herein refers to the section of the extension element that lacks properties of elasticity and does not stretch upon application of an external force. Moreover, the non-elasticated section of the device remains relatively rigid and does not easily stretch or deform when the external force is applied thereto. Notably, the first section is fabricated from a material that maintains a relatively constant length thereof and does not easily deform or elongate when subjected to forces or tension. Optionally, the first section is fabricated using a non-elastic material such as plastic, leather, fabric, and the like. Beneficially, the first section provides a specific and unchanging length of the device, and therefore plays a crucial role in applications that require stability, rigidity, or precision in length for the proper functioning of an associated system (such as a sports equipment, a car seat, and so on).

Optionally, the tensile strength of the first section is in a range of 0.3 Pa to 1 kPa. Optionally, the tensile strength of the first section may for example be in a range of 0.3, 0.4, 0.5, 0.6, 0.7, 0.8 or 0.9, 1, 10, 50, 100, 200, 400, 600 or 800 Pa up to 0.4, 0.5, 0.6, 0.7, 0.8, 0.9, 1, 10, 50, 100, 200, 400, 600, 800 or 1000 Pa. It will be appreciated that by adjusting the tensile strength of the first section, the device can withstand tensile forces without breaking of deforming and ensure structural integrity and durability of the device.

The term “elasticated section” as used herein refers to the part of the extension element that has inherent elastic properties due to the nature of fabrication material used therein. Typically, the elasticated section allows the extension element to stretch longitudinally when the external force is applied thereto. Herein, the elasticated section is configured to keep the first end and the second end of the extension element consistently pulled towards each other. The technical effect of employing the second section is that it provides a consistent tension between the first and second ends of the extension element, thereby creating an antagonistic pairing effect on the loose ends of the strap, that are held by the device, to keep it fully tightened. Moreover, another technical effect of keeping the elasticated section in the at least partially middle region is to allow consistent predefined tension on the extension element equally, and securely hold the object or the loose ends of the strap.

Optionally, the elastic modulus of the second section is in a range of 1 Pa to 100 GPa. Optionally, the elastic modulus of the second section may for example be in a range of 1 Pa, 10 Pa, 20 Pa, 30 Pa, 50 Pa, 100 Pa, 500 Pa, 1kPa, 50 kPa, 100 kPa, 500 kPa, 1MPa, 50 MPa, 100 MPa, 500 MPa, 1 GPa or 50 GPa up to 10 Pa, 20 Pa, 30 Pa, 50 Pa, 100 Pa, 500 Pa, 1kPa, 50 kPa, 100 kPa, 500 kPa, 1MPa, 50 MPa, 100 MPa, 500 MPa, 1 GPa, 50 GPa or 100 GPa. It may be appreciated that by adjusting the elastic modulus of the second section, the second section can resist deformation under applied external force and maintain the shape and form, and allows the extension element to stretch longitudinally when the external force is applied thereto.

Therefore, a combination of the elasticated and the non-elasticated section plays a crucial role in the functionality of the device, providing adaptability and ensuring that the device can effectively secure and manage loose ends of tightened straps. Herein, the elasticated section due to its property of stretching itself, change its length according to the needs of the user and the non-elasticated part helps the users to manage the length of the device to its maximum capacity.

Optionally, the second section comprises a plurality of layers of an elastic material stacked together, and wherein each layer of the elastic material has a different length. The term “elastic material” as used herein refers to the material that has the property of elasticity and it will stretch when external force is applied on it. Moreover, such property of the elastic material is due to the material's molecular structure, which allows it to deform under stress and then recover to its original form. Optionally, the second section is fabricated from a flexible material such as rubber, spandex, elastomers, elastic band, and so on. Herein, the stack of the plurality of layers of the elastic material results from parallelly arranging the corresponding first ends and second ends of the plurality of layers of the elastic material. For example, in a stack of three layers of the elastic material, the corresponding first ends of the first, second and third layers of elastic materials are arranged one beneath the other, and similarly, the corresponding second ends of the first, second and third layers of elastic materials are arranged one beneath the other, to form the second section.

Optionally, the plurality of layers of the elastic material of the second section are attached separately (not as a pre-assembled second section) to the first section at the first and second attachment points of the extension element, respectively. Moreover, a distance between the first and second attachment points of the extension element is equal to or less than the shortest layer of the second section.

Alternatively, the second section comprising the plurality of layers of the elastic material is pre-assembled prior to its attachment to the first section at the first and second attachment points of the extension element, respectively. In this regard, the corresponding first ends and second ends of the plurality of layers are attached at a third attachment point of the second section and a fourth attachment point of the second section, respectively. Optionally, the corresponding first ends and second ends of the first, second and third elastic materials are attached at the third attachment point and the fourth attachment point, respectively, by means of adhesive, stitches, threads, snap buttons, and so on. Subsequently, the corresponding first ends and second ends of the plurality of layers attached at the third attachment point and the fourth attachment point of the second section, respectively are arranged and attached at the at least partially middle region of the first section at the first attachment point and the second attachment point of the extension element, respectively. Notably, the first attachment point and the second attachment point of the extension element lie superimposed on the third attachment point and the fourth attachment point of the second section, respectively.

Moreover, the length of each layer of the stack decreases with an increasing distance thereof from the first section. In this regard, with reference to the above example, the first layer that is closest to the first section is longer than the second layer that is arranged beneath the first layer in the stack of the plurality of layers, and the second layer is longer than the third layer that is arranged beneath the second layer in the stack of the plurality of layers. It may be appreciated that elasticity or elastic modulus of each of the first, second and third layers of elastic materials may be similar to or distinct from each other. Notably, when the elastic modulus of each of the first, second and third layers of elastic materials is distinct from each other, the elastic modulus is indirectly proportional to the length of the first, second and third layers of elastic materials. For example, the lengths of the first, second and third layers of elastic materials are 70 cm (longest), 55 cm (medium) and 30 cm (shortest), respectively. Referring to the above example, the elastic modulus of the first, second and third layers of elastic materials are 20 Pa (lowest), 50 Pa (medium) and 100 Pa (highest), respectively. Beneficially, the different length of each layer of the elastic material allows the device to stretch according to the size of the object which needs securing. Additionally, increasing elastic modulus of the elastic material with increasing distance thereof from the first section allows for more extension of the elastic material with highest elastic modulus to provide a comfortable fit around an object, when in use.

Optionally, the first section comprises a patch layer arranged between the first section and the second section, wherein the patch layer is fabricated from a same or similar fabrication material of the first section. Herein, the patch layer has a length that is comparable to the second section, for example, the first layer of the second section, and is much shorter than the first section. Beneficially, the patch layer reinforces and provides more strength to the first section.

Optionally, when in a relaxed state, the second section and a part of the first section bearing the second section form a loop structure at the at least partially middle region of the length of the first section, and when in stressed state, the second section and the part of the first section bearing the second section lie parallel to an axis of the extension element. Herein, the term “relaxed state” refers to a state in which there is no external force or stress applied on the device, and both the elasticated and non-elasticated section of the device are in their initial or normal conformation (i.e., unstressed or undistorted state), when there is no external force applied thereto. The term “loop structure” as used herein refers to a configuration or the closed path formed by the plurality of second section and the first section of the device, when they are in the relaxed state. During the relaxed state, the loop structure is formed at the at least partially middle region of the length of the first section in between the first and second attachment points, and the length of the first section is greater than the plurality of layers of the second section. Moreover, the combination of non-elasticated and elasticated sections of the loop may undergo deformations under applied forces, and the nature of these deformations may vary depending on the properties of the specific material of the first and second sections.

The term “stressed state” as used herein refers to a state of application of an external force on components (such as the extension element) of the device. Moreover, the stressed state indicates a condition where the extension element is under a predefined tension, such as a longitudinal pull, that causes it to extend beyond its relaxed state. It will be appreciated that when the extension element is in the stressed state, then the second section which is fabricated from elastic material and, the part of the first section which is fabricated from non-elastic material, lie parallel to the axis of the extension element as a result of stretching of the elastic material of the second section. The term “axis” as used herein refers to a straight imaginary line passing through the extension element, along a length thereof. The two ends of the extension element will move parallel to this imaginary line when the external force is applied on the extension element. It may be appreciated that the amplitude (height) of elements (namely the first section and each of the plurality of layers of the second section) of the loop structure depends on the distance between the first and second attachment points of the extension element. In an example, when the distance between the first and second attachment points of the extension element is equal to the shortest layer of the second section, the shortest layer does not form the loop in the relaxed state. In an example, when the distance between the first and second attachment points of the extension element is less than the shortest layer of the second section, the shortest layer forms the loop in the relaxed state. It may be appreciated that in a 100% stressed state (i.e., fully-extended state), the length of the second section will extend to achieve a length comparable to the length of the first section. For example, if the length of the first section is 90 cm, the length of the second section will be 90 cm in its 100%-stressed state. In such case, the first section and the second section overlap each other along the axis with no visible loop structure. Similarly, in a 50% stressed state, if the length of the first section is 90 cm, the length of the second section will be 45 cm. In such case, the loop structure of the first section and the second section are still visible. The term “fastener” as used herein refers to a hardware element (or component) of the device used to secure the loose end(s) of the strap. In this regard, the fastener is attached at an end (namely, the first end and/or the second end, the third end, and so on) of the extension element. Optionally, the at least one of the at least one ends of the extension element is implemented as an attachment loop or fastening loop configured to receive and secure the first section to the fastener(s) from a mounting end of the fastener. Optionally, the attachment loop or fastening loop is created by bending over a part of the first section (towards an end(s) of the first section) over the mounting end of the fastener, and bonding the bent over part of the first section while leaving a groove (or ring-like space) around the mounting end of the fastener.

Optionally, the attachment loop or fastening loop is created by bending over the part of the first section that is outside the at least partially middle section over the mounting end of the fastener, and bonding the bent over part of the first section while leaving a groove (or ring-like space) around the mounting end of the fastener. Optionally, the bent part of the first section is bonded adjacent to the first attachment point and the second attachment point of the extension element, respectively. Beneficially, the bent-bonded part of first and second ends of the first section provides more strength to the first section. Moreover, placing the bent-bonded part of the first end and the bent-bonded part of the second end of the first section, near to the first attachment point and the second attachment point, respectively enables in equal distribution of the tension along the extension element, when the external force is applied thereto. It may be appreciated that when the device is in the stressed state (i.e., the external force is applied on the device), the third and fourth attachment points of the second section are arranged adjacent to the bent-bonded parts of the first and second ends of the first section, respectively.

The fastener comprises an attachment end distinct from the mounting end thereof. Herein, the attachment end is arranged opposite to the mounting end of the fastener, to provide the antagonistic pairing between the loose end(s) of the strap and the fasteners. Notably, the attachment end is implemented as an open space for receiving the loose end of the strap. Moreover, the fastener typically comprises a clamping or gripping mechanism for firmly holding the received loose end(s) of the strap.

Optionally, the fastener comprises a sprung set of teeth. The term “sprung set of teeth” as used herein refers to a clamping or gripping mechanism employing pointed spikes or teeth to engage with the loose end of the strap, to provide a secure grip thereto. Optionally, the sprung set of teeth is provided towards the attachment end of the fastener. It may be appreciated that the sprung set of teeth help the fastener to hold the strap tightly by providing a required friction therebetween. Beneficially, the sprung set of teeth of the fastener help the device to handle the excess tension applied on it during the stressed state, thereby maintaining the antagonistic pairing of the device and the loose ends of the strap.

Optionally, the device comprises a pair of fasteners, wherein each fastener is arranged on the corresponding first end and second end of the extension element and is configured to receive a corresponding loose end of the strap therethrough. In other words, the device comprises a first fastener arranged at the first end of the extension element and a second fastener arranged at the second end of the extension element, configured to receive a first loose end and a second loose end of the strap, respectively. Notably, the at least one first loose end and the at least one second loose end of the strap are received in the first fastener and the second fastener via corresponding attachment ends of the first fastener and the second fastener, respectively. It may be appreciated that, in this regard, the pair of fasteners are designed to receive and firmly hold the loose ends of the strap for creating a secure connection and antagonistic paring therebetween. Beneficially, the connection between the fastener and the strap is, namely the antagonistic paring therebetween, creates a reliable and durable connection between the device and the strap, thereby, preventing them from separating unintentionally.

Optionally, the fastener is implemented as a clip. The term “clip” as used herein refers to a mechanical component designed to hold an incoming thing (such as loose end(s) of the strap) together. In this regard, the clip-type fasteners typically involve a clamping or gripping mechanism for easy attachment and removal without the need for additional tools. Moreover, the clip may be designed in various shapes, sizes and by using different fabrication materials (metal, plastic, or a combination thereof), based on the application thereof. The technical effect of implementing the fastener as a clip allows bridging the loose end(s) of the strap for creating the antagonistic pair therebetween, while enabling rapid assembling (attachment) and disassembling (detachment) thereof.

Optionally, the clip is implemented as a quick-release clip. The term “quick-release clip” as used herein refers to a type of mechanical component that is designed for easy and rapid attachment or detachment of the device and the loose ends of the strap. The quick-release clip is designed to be easily operated by hand for opening and closing it, without needing additional tools or extensive manual effort. In this regard, the quick-release clip can be opened by means of a lever, a button, a switch, a latch, a hook-loop arrangement, a catch-eyelet arrangement, or other intuitive controls. For example, many backpacks feature quick release clips on their straps, allowing users to easily open and close the buckles for quick access to the contents. Typically, the quick-release clip allows the loose end of the strap to pass therethrough in its open conformation, and tightly holding the received strap via the grasping or clamping mechanism in its closed confirmation.

Optionally, the second section creates a predefined tension between the pair of fasteners. The term “predefined tension” as used herein refers to the specific and predetermined level of force experienced by the fasteners as a result of the elastic modulus of the plurality of layers of the second section. The predefined tension creates a consistent pulling force between the fasteners. Beneficially, the predefined tension creates the antagonistic pairing between the device and the loose ends of the strap, by consistently pulling the fasteners towards each other (i.e., towards the centre of the extension element).

Optionally, the predefined tension between the pair of fasteners is in a range of 0.01 to 100 kN. Optionally, the predefined tension between the pair of fasteners may be for example in a range of 0.01, 0.1, 1, 10 or 50 kN up to 0.1, 1, 50 or 100 kN. It may be appreciated that by adjusting the predefined tension between the pair of fasteners, it is possible to control the antagonistic pairing between the device and the loose ends of the straps and the predefined tension can ensure that the loose ends of the strap is securely fastened to the device.

### Experimental Part

Adjustable foot straps on a rowing machine: During a rowing session, the user had to tighten the foot straps of the rowing machine multiple times, to provide stability and controlled fit to the foot as well as the conventional rowing machines. The user used the disclosed device to address the aforementioned drawback of the conventional rowing machine. The user attached the first and second fasteners of the disclosed device to the loose ends of the foot strap of the rowing machine and the length of the loose ends of the strap were adjusted across the first and second fasteners to arrange the second section over the foot of the user. Notably, the adjusted device held the foot of the user in place during the entire rowing exercise regimen.

Backpack straps extensions: During a trek, the user used the disclosed device to create additional space for carrying additional item(s) required for the trek. The user attached the first and second fasteners of the disclosed device to the loose ends of the strap of the backpack and the length of the loose ends of the strap were adjusted across the first and second fasteners to arrange the second section over the additional item(s) carried. Notably, the adjusted device held the additional item(s) securely in place during the entire trek.

### DETAILED DESCRIPTION OF THE DRAWINGS

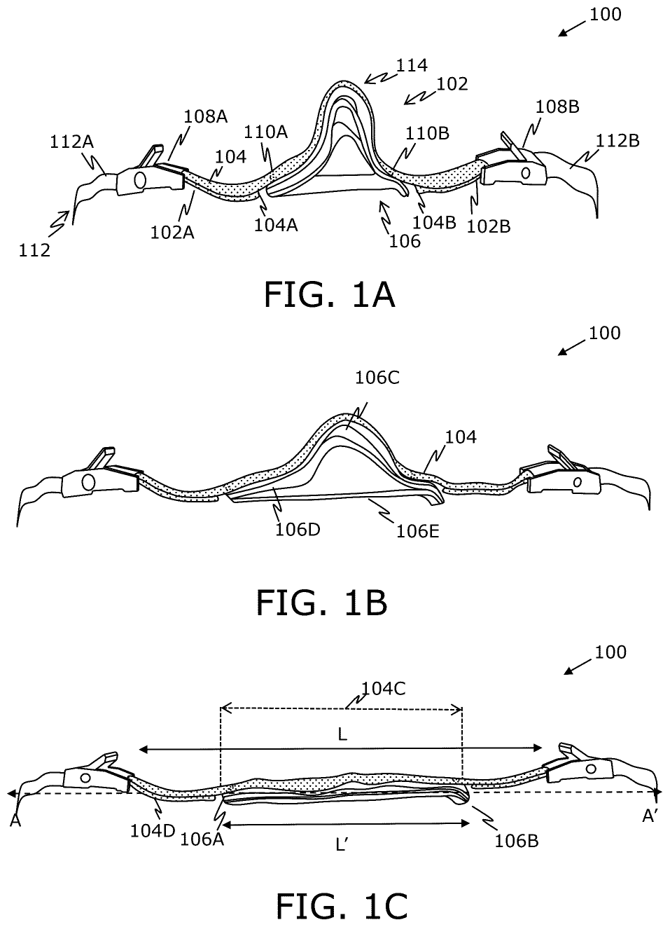

Referring to FIGS. 1A, 1B and 1C, illustrated are illustrations of a device 100 in a relaxed state, a partially-stressed state and a stressed state, respectively, in accordance with an embodiment of the present disclosure. As depicted in FIGS. 1A, 1B and 1C, the device 100 comprises an extension element 102 and fasteners 108A and 108B. Moreover, the extension element 102 comprises a first section 104 and second section 106. As shown, the first section 104, having a length L, extends between the first end 102A and the second end 102B of the extension element 102. The second section 106, having a length L′, is arranged along the length L of the first section 104, such that ends 106A and 106B of the second section 106 are attached to the first section 104. Moreover, as shown, the second section 106 is arranged along at least partially middle region 104C of the length L of the first section 104 at attachment points 110A and 110B. Moreover, as shown, the second section 106 comprises a plurality of layers 106C, 106D, 106E stacked together, wherein each layer of the elastic material has a different length. The fasteners 108A and 108B are arranged on the corresponding first end 102A or second end 102B of the extension element 102, respectively, and the fasteners 108A and 108B are configured to receive the corresponding loose end 112A and 112B of the strap 112. As shown, the fasteners 108A and 108B are implemented as quick-release clips, and arranged on the corresponding first end 102A or second end 102B of the extension element 102, respectively, that are implemented as attachment loop or fastening loop by bending over a part 104D of the first section (towards a first end 104A and a second end 104B of the first section 104A) over a mounting end of each fastener 108A and 108B, and bonding the bent over part 104D of the first section 104 while leaving a groove (or ring-like space) around the mounting end of the fastener 108A and 108B.

As shown in FIG. 1A, in the relaxed state, the second section 106 and a part of the first section bearing the second section 106, form a loop structure 114 at the at least partially middle region 104C of the length L of the first section 104, in between the attachment points 110A and 110B. As shown, the first end 102A or second end 102B of the extension element 102 are not a part of the loop structure 114.

As shown in FIG. 1B, in the partially-stressed state, the broadness of the loop structure 114 increases linearly with the external force applied on the device.

As shown in FIG. 1C, in the stressed state, i.e. when external force applied on the device is higher than the external force applied on the device as in the partially-stressed state, the second section 106 and the part of the first section 104 which bears the second section 106 lie parallel to an axis (A-A′) of the extension element 102.

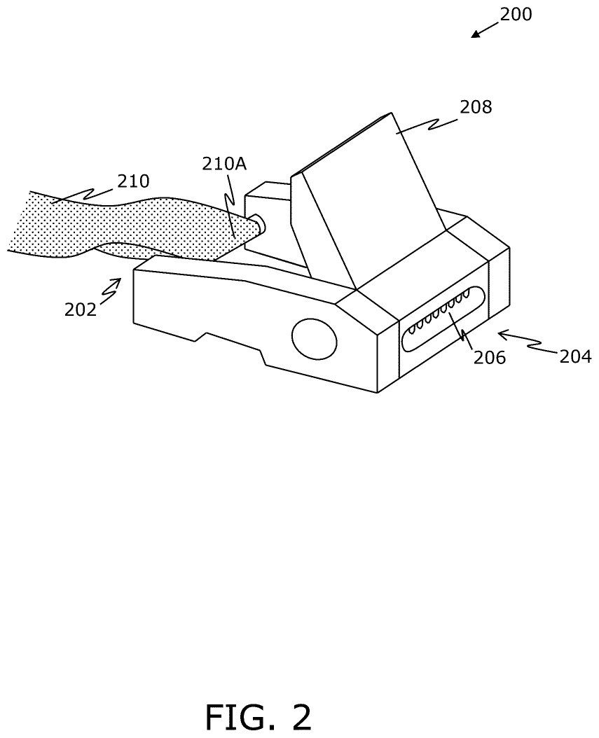

Referring to FIG. 2, illustrated is an illustration of the fastener 200, which is implemented as a clip, more specifically as quick-release clip. The fastener 200 has a mounting end 202 and an attachment end 204. The fastener 200 has a sprung set of teeth 206 at the attachment end 204 and a quick release switch 208. As shown, the mounting end 202 is attached to the first end 210A (such as the first end 102A of FIG. 1) of the extension element 210 (such as the extension element 102 of FIG. 1). Notably, the attachment end 204 is designed to receive a loose end of a strap, when the device is in use.

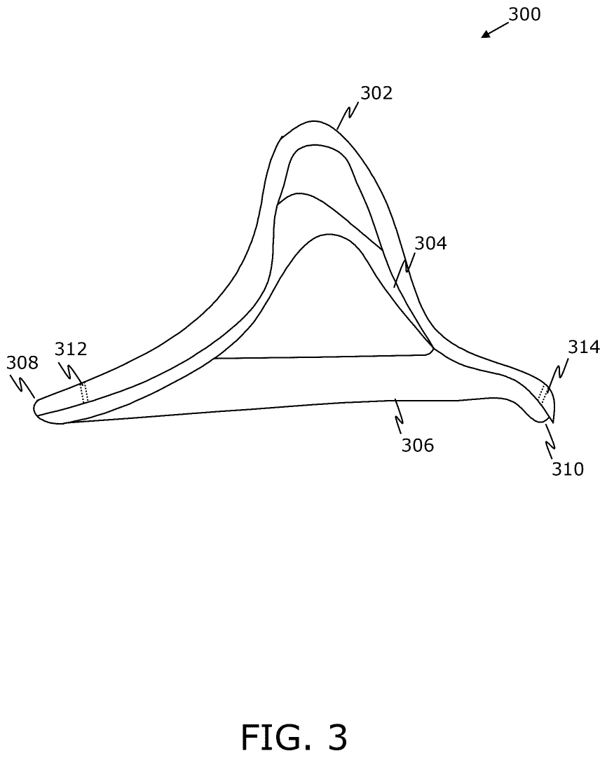

FIG. 3 is an illustration of a preassembled second section 300, in accordance with an embodiment of the present disclosure. As shown, the second section 300 comprises a plurality of layers, namely a first layer 302, a second layer 304 and a third layer 306, stacked together, wherein the first layer 302 is arranged closest to a first section (such as a first section 104 of FIG. 1), followed by the second layer 304 and the third layer 306. As shown, each layer 302, 304 and 306 has a different length, wherein the first layer 302 is the longest, the third layer 306 is the shortest, and the second layer 304 is shorter than the first layer 302 and longer than the third layer 306, the length of each layer 302, 304 and 306 of the stack decreases with an increasing distance thereof from the first section. Notably, the stack of the plurality of layers 302, 304 and 306 results from parallelly attaching the corresponding first ends 308 and second ends 310 of the plurality of layers 302, 304 and 306 one beneath the other, at a third attachment point 312 of the second section 300 and a fourth attachment point 314 of the second section 300, respectively. As shown, the corresponding first ends 308 and second ends 310 of the first, second and third layers 302, 304 and 306 are attached at the third attachment point 312 and the fourth attachment point 314, respectively, by means of stitches.

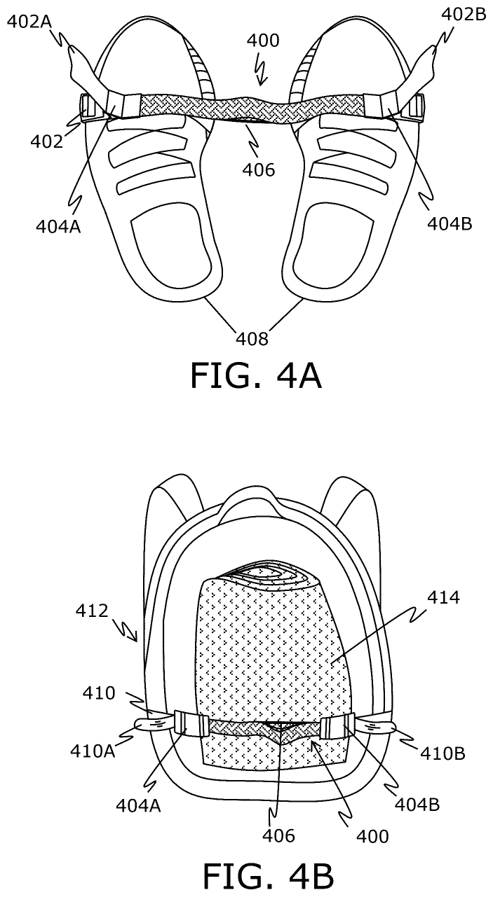

FIGS. 4A and 4B are exemplary implementations of a device 400, in accordance with an embodiment of the present disclosure. As shown in FIG. 4A, loose ends 402A and 402B of adjustable foot strap 402 on an equipment, such as a rowing machine for example, are secured using the device 400. As shown, the first fastener 404A and second fastener 404B of the device 400 receive the loose ends 402A and 402B of the adjustable foot strap of the equipment and the length of the loose ends 402A and 402B of the adjustable foot strap are adjusted across the first and second fasteners 402A and 402B to arrange the second section 406 of the device 400 over the foot 408 of the user to secure the foot 408 of the user in place for the desired duration.

As shown in FIG. 4B, straps 410 of a backpack 412 are secured in position using the device 400 to create an additional space for carrying an object 414 on the outside of the backpack 412. Similar to the implementation of FIG. 4A, the first fastener 404A and second fastener 404B of the device 400 receive the loose ends 410A and 410B of the straps 410 of a backpack 412 and the length of the loose ends 410A and 410B of the straps 410 are adjusted across the first and second fasteners 404A and 404B to arrange the second section 406 of the device 400 over the object 414 to secure the foot object 414 in place for the desired duration.

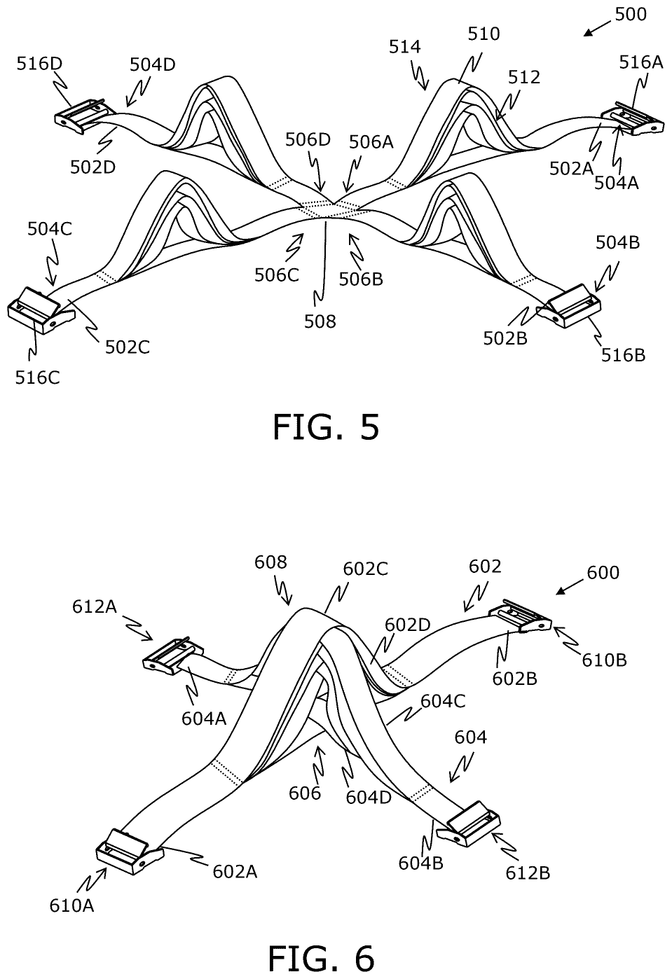

FIG. 5 is a schematic illustration of a device 500 in a relaxed state thereof, in accordance with an alternative embodiment of the present disclosure. As shown, the device 500 comprises 4 extension elements 502A, 502B, 502C and 502D having 4 loose first ends 504A, 504B, 504C and 504D, and 4 fixed second ends 506A, 506B, 506C and 506D fixed at a centre 508 of the device 500. Moreover, each of the extension elements 502A, 502B, 502C and 502D comprises a first section 510 and second section 512 as disclosed in FIG. 1A. Moreover, each of the second section 512 and a part of the first section 510 bearing the second section 512, form a loop structure 514 at the at least partially middle region of the length of the first section 510. As shown, the loose first ends 504A, 504B, 504C and 504D and the fixed second ends 506A, 506B, 506C and 506D of the extension elements 502A, 502B, 502C and 502D are not a part of the loop structure 514. Moreover, the device 500 comprises fasteners 516A, 516B, 516C and 516D (implemented as quick-release clips) attached to the 4 loose ends 504A, 504B, 504C and 504D, respectively, and configured to receive loose ends of straps.

FIG. 6 is a schematic illustration of a device, in accordance with an alternative embodiment of the present disclosure. As shown, the device 600 comprises two extension elements 602 and 604 arranged such that they intersect each other to form a cross-like design 606. In such case, the device 600 has 2 first ends 602A and 604A and two second ends 602B and 604B corresponding to the extension elements 602 and 604, respectively. Moreover, the extension elements 602A and 604 comprise a first section 602C and 604C and second section 602D and 604D, respectively as disclosed in FIG. 1A. Moreover, each of the second section 602D and 604D and a part of the first section 602C and 604C bearing the second section 602D and 604D, form a loop structure 608 at the at least partially middle region of the length of the first section 602C and 604C. As shown, the extension elements 602 and 604 intersect each other at the loop structure 608, such that the first section 602C and 604C and the second section 602D and 604D. Moreover, the device 600 comprises fasteners 610A, 612A, 610B and 612B (implemented as quick-release clips) attached to the first ends 602A and 604A and two second ends 602B and 604B, respectively, and configured to receive loose ends of straps.

1. A device (100, 400, 500, 600) for in-position securing at least one loose end (112A, 112B, 402A, 402B, 410A, 410B) of at least one strap (112, 402, 410), the device comprising:
an extension element (102, 210, 502A, 502B, 502C, 502D, 602, 604) having at least one first end (102A, 210A, 504A, 504B, 504C, 504D, 602A, 604A) and at least one second end (102B, 506A, 506B, 506C, 506D, 602B, 604B), the extension element comprising;
a first section (104, 510, 602C, 604C), having a length (L), extending between the at least one first end and the at least one second end; and
a second section (106, 300, 512, 602D, 604D) arranged along the length of the first section such that ends (106A, 106B, 308, 310) of the second section are attached to the first section; and
a fastener (108A, 108B, 200, 404A, 404B, 516A, 516B, 516C, 516D, 610A, 612A, 610B, 612B) arranged on at least one corresponding at least one first end, at least one second end of the extension element, the at least one fastener configured to receive the corresponding loose end of the at least one strap therethrough.

2. A device (100, 400, 500, 600) of claim 1, wherein the device comprises a pair of fasteners (108A, 108B, 200, 404A, 404B, 516A, 516B, 516C, 516D, 610A, 612A, 610B, 612B), wherein each fastener is arranged on the corresponding first end (102A, 210A, 504A, 504B, 504C, 504D, 602A, 604A) and second end (102B, 506A, 506B, 506C, 506D, 602B, 604B) of the extension element (102, 210, 502A, 502B, 502C, 502D, 602, 604) and is configured to receive a corresponding loose end (112A, 112B, 402A, 402B, 410A, 410B) of the strap (112, 402, 410) therethrough.

3. A device (100, 400, 500, 600) of claim 1, wherein the first section (104, 510, 602C, 604C) is implemented as a non-elasticated section, and the second section (106, 300, 512, 602D, 604D) is implemented as an elasticated section.

4. A device (100, 400, 500, 600) of claim 1, wherein the second section (106, 300, 512, 602D, 604D) is arranged along at least partially middle region (104C) of the length (L) of the first section (104, 510, 602C, 604C).

5. A device (100, 400, 500, 600) of claim 1, wherein the second section (106, 300, 512, 602D, 604D) comprises a plurality of layers (106C, 106D, 106E, 302, 304, 306) of an elastic material stacked together, and wherein each layer of the elastic material has a different length (L′).

6. A device (100, 400, 500, 600) of claim 5, wherein
when in a relaxed state, the second section (106, 300, 512, 602D, 604D) and a part of the first section (104, 510, 602C, 604C) bearing the second section form a loop structure (114, 514, 608) at the at least partially middle region (104C) of the length (L) of the first section, and
when in stressed state, the second section and the part of the first section bearing the second section lie parallel to an axis (A-A′) of the extension element (102, 210, 502A, 502B, 502C, 502D, 602, 604).

7. A device (100, 400, 500, 600) of claim 1, wherein the fastener (108A, 108B, 200, 404A, 404B, 516A, 516B, 516C, 516D, 610A, 612A, 610B, 612B) is implemented as a clip.

8. A device (100, 400, 500, 600) of claim 7, wherein the clip is implemented as a quick-release clip.

9. A device (100, 400, 500, 600) of claim 1, wherein the fastener (108A, 108B, 200, 404A, 404B, 516A, 516B, 516C, 516D, 610A, 612A, 610B, 612B) comprises a sprung set of teeth (206).

10. A device (100, 400, 500, 600) of claim 1, wherein the length (L) of the first section (104, 510, 602C, 604C) is in a range of 2 to 100 cm.

11. A device (100, 400, 500, 600) of claim 1, wherein the length (L′) of the second section (106, 300, 512, 602D, 604D) is in a range of 1.6 to 80 cm.

12. A device (100, 400, 500, 600) of claim 1, wherein a tensile strength of the first section (104, 510, 602C, 604C) is in a range of 0.3 Pa to 1 kPa.

13. A device (100, 400, 500, 600) of claim 1, wherein an elastic modulus of the second section (106, 300, 512, 602D, 604D) is in a range of 1 to 100 GPa.

14. A device (100, 400, 500, 600) of claim 13, wherein the second section (106, 300, 512, 602D, 604D) creates a predefined tension between the pair of fasteners (108A, 108B, 200, 404A, 404B, 516A, 516B, 516C, 516D, 610A, 612A, 610B, 612B).

15. A device (100, 400, 500, 600) of claim 14, wherein the predefined tension between the pair of fasteners (108A, 108B, 200, 404A, 404B, 516A, 516B, 516C, 516D, 610A, 612A, 610B, 612B) is in a range of 0.01 to 100 kN
